(19) United States
(12) Patent Application Publication
(10) Pub. No.: US 2007/0226724 A1
(43) Pub. Date: Sep. 27, 2007

(54) Method and apparatus for firmware execution and provision

(75) Inventor: Chi-Hung Huang, Keelung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/388,691

(22) Filed: Mar. 24, 2006

(51) Int. Cl. G06F 9/44

(52) U.S. Cl. 717/162

(57) ABSTRACT

Methods and apparatuses for firmware execution and provision are provided. A ROM device stores compressed firmware. A decompressor is coupled to the ROM device, extracting the compressed firmware to a first instruction stream comprising at least one absolute address instruction. A post-filter, coupled to the decompressor, filters the first instruction stream to generate a second instruction stream, whereby the absolute address instruction is converted to a relative address instruction. A RAM device, coupled to the post-filter, stores the second instruction stream filtered from the post-filter. A CPU is coupled to the RAM device, executing the second instruction stream stored in the RAM device.

### BACKGROUND OF THE INVENTION

1. Field of the Invention

The invention relates to firmware, and in particular, to method and apparatus for firmware compression and decompression.

2. Description of the Related Art

FIG. 1a shows a conventional firmware execution. In a typical embedded system powered by firmware, the firmware is stored in a ROM device 104 in a compressed form. The compressor 102 may be provided by a vendor doing manufacture of the ROM device 104. The most popular compression algorithms, LZ77 and LZ78, are known as dictionary based algorithms, whereby repetitive patterns in input data are converted to compact indices to economize capacity. Input data comprising more repetitive patterns can be more highly compressed. In FIG. 1, a decompressor 106 is provided to instantly decompress the firmware into the RAM 108, after which the CPU 110 can directly access the RAM 108 to execute the firmware.

FIG. 1b shows an instruction structure block. The firmware here is an instruction sequence comprising a plurality of consecutive instructions. Each instruction may be 16 or 32 bits, with some bits forming a command code and others an offset value. The command code indicates predetermined operating numbers for the CPU 110 to execute. The offset value represents a relative address of data or other instruction referred by the corresponding command code.

FIG. 1c shows a memory map with instructions distributed therein. The compressed firmware stored in the ROM device 104 is decompressed and stored in the RAM 108 to form the memory map. In the firmware, a first instruction Ins1 comprises an offset value L1 referring to a third instruction Ins3. The offset value in a second instruction Ins2 is L2, also referring to the address of third instruction Ins3. The memory map may comprise more than two instructions of the format shown in FIG. 1b, each having a varied offset value referring to the same instruction Ins3. The capacity of ROM device 104 and decompression speed of the decompressor 106 are both critical resources since the firmware is decompressed and executed in real time. An improved mechanism is desirable to enhance the execution performance.

### BRIEF SUMMARY OF THE INVENTION

A detailed description is given in the following embodiments with reference to the accompanying drawings.

An exemplary embodiment of a firmware executing device is provided, in which a ROM device stores compressed firmware. A decompressor is coupled to the ROM device, extracting the compressed firmware to a first instruction stream comprising at least one absolute address instruction. A post-filter, coupled to the decompressor, filters the first instruction stream to generate a second instruction stream, whereby the absolute address instruction is converted to a relative address instruction. A RAM device, coupled to the post-filter, stores the second instruction stream filtered from the post-filter. A CPU is coupled to the RAM device, executing the second instruction stream stored in the RAM device.

The post-filter comprises a buffer, a type detector, a program counter and a plurality of decoders. The buffer has sufficient capacity to collect one or more absolute address instructions, jointly comprising an address field directly pointing to an absolute address. The type detector, coupled to the buffer, determines which type the absolute address instruction is. The program counter provides address indexes for the absolute address instructions. The decoders are coupled to the buffer and the program counter, individually converting different absolute address instruction types to corresponding relative address instructions with reference to the address indexes provided by the program counter. The multiplexer is coupled to the buffer, type detector, and decoders, selecting one of the outputs from the buffer and decoders according to the type determined by the type detector, and outputting the selection as the relative address instruction.

The decompressor extracts the compressed firmware by a dictionary decompression algorithm. When type of the absolute address instruction is detected, a corresponding decoder of the type rewrites the address field with an offset value, obtained by the targeted absolute address subtracting the corresponding address indexes.

Another embodiment provides a firmware supplier coupled to a ROM device to provide compressed firmware, comprising a pre-filter and a compressor. The pre-filter filters original firmware comprising at least one relative address instruction to generate encoded firmware, whereby the relative address instruction in the original firmware is converted to an absolute address instruction. The compressor is coupled to the pre-filter, compressing the encoded firmware to the compressed firmware by a dictionary compression algorithm. The ROM device is coupled to the compressor, storing the compressed firmware.

Further embodiments provide methods of firmware execution and provision implemented by the devices disclosed.

### BRIEF DESCRIPTION OF THE DRAWINGS

The invention can be more fully understood by reading the subsequent detailed description and examples with references made to the accompanying drawings, wherein:

FIG. 1a shows a conventional firmware execution;

FIG. 1b shows an instruction structure block;

FIG. 1c shows a memory map with instructions distributed therein;

FIG. 2 shows an embodiment of a firmware supplier 210 and a firmware execution device 220;

FIG. 3a shows an embodiment of a pre-filter 202 according to FIG. 2;

FIG. 3b shows an embodiment of absolute address calculation;

FIG. 4a shows an embodiment of a post-filter 204 according to FIG. 2

FIG. 4b shows an embodiment of relative address calculation; and

FIG. 5 is a flowchart of the firmware provision and execution method.

### DETAILED DESCRIPTION OF THE INVENTION

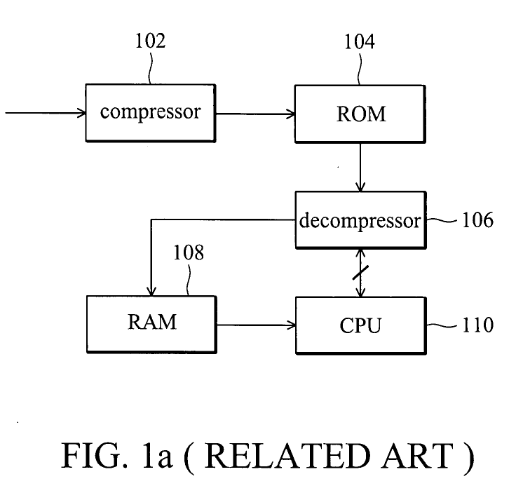

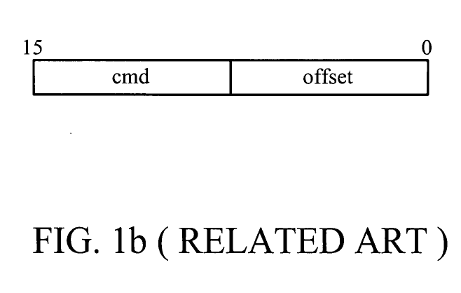

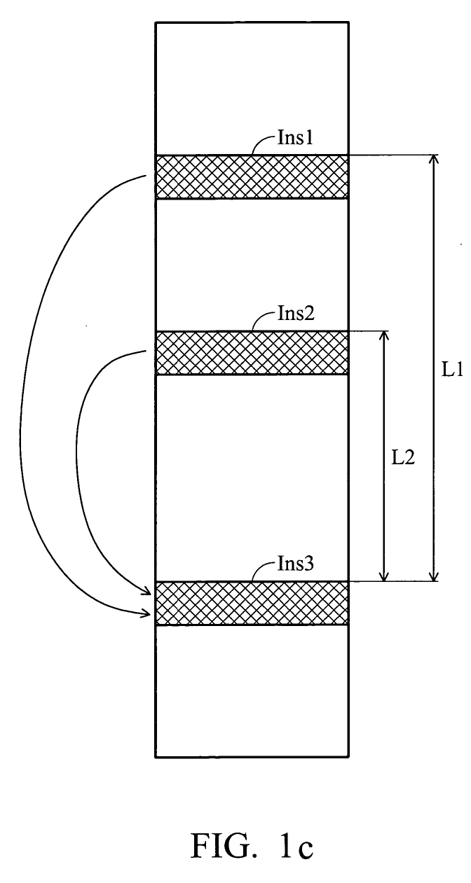

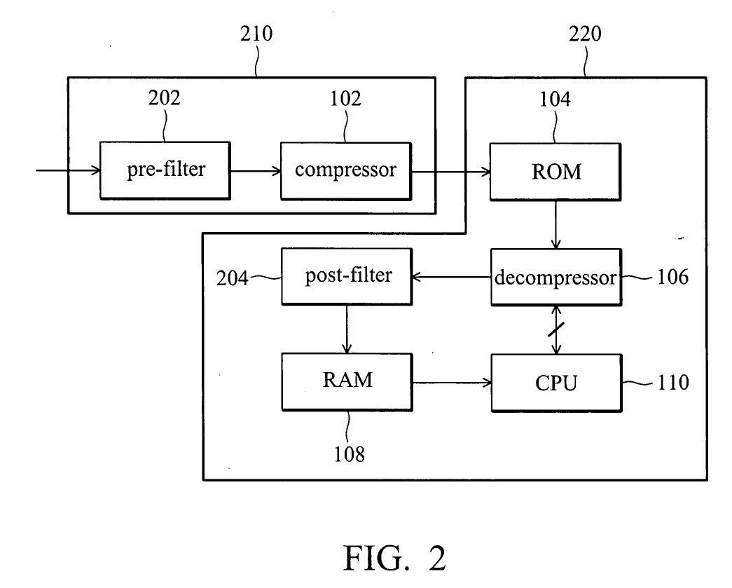

FIG. 2 shows an embodiment of a firmware supplier 210 and a firmware execution device 220. The firmware supplier 210 generates a compressed firmware, and the firmware execution device 220 decompresses the compressed firmware and executes it. Since the firmware stored in the ROM device 104 is compressed by a dictionary based algorithm, increased repetitive patterns leads to higher compression rate. The firmware supplier 210 comprises a pre-filter 202 and a compressor 102. The pre-filter 202 converts original firmware to an encoded firmware. The original firmware comprises a plurality of relative address instructions as shown in FIG. 1b, with offset values relatively pointing to the referred instruction such as the third instruction Ins3 in FIG. 1c. The pre-filter 202 converts the relative address instructions to absolute address instructions, in which the offset values referring to the third instruction Ins3 are modified to the address of the third instruction Ins3. Thus, the encoded firmware is an optimized version comprising more repetitive patterns than the original firmware. The compressor 102 then compresses the encoded firmware and sends it to the ROM device 104 for storage. When the firmware execution device 220 is powered up, the decompressor 106 is initialized to read and decompress the encoded firmware from the ROM device 104. A post-filter 204 is provided to perform an operation opposite to the pre-filter 202, such that the encoded firmware is decoded and written to the RAM device 108, comprising the relative address instructions as the origin.

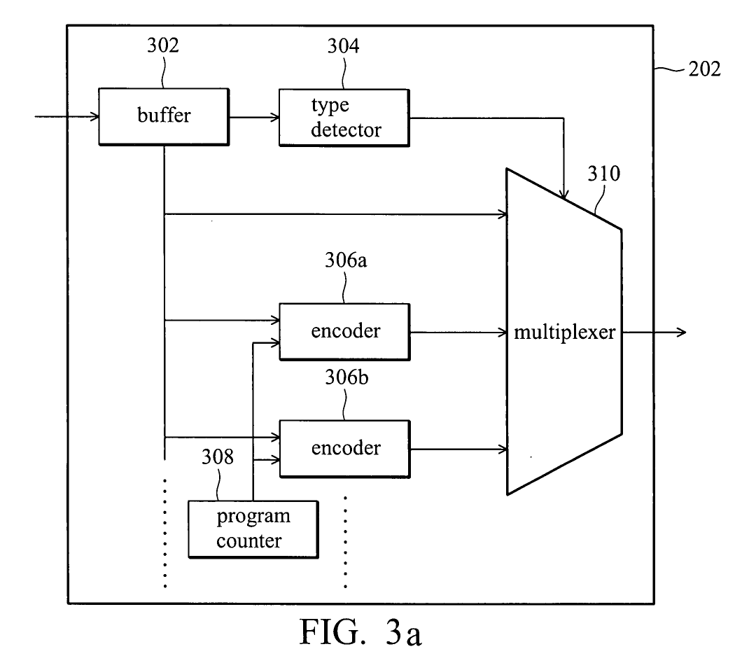

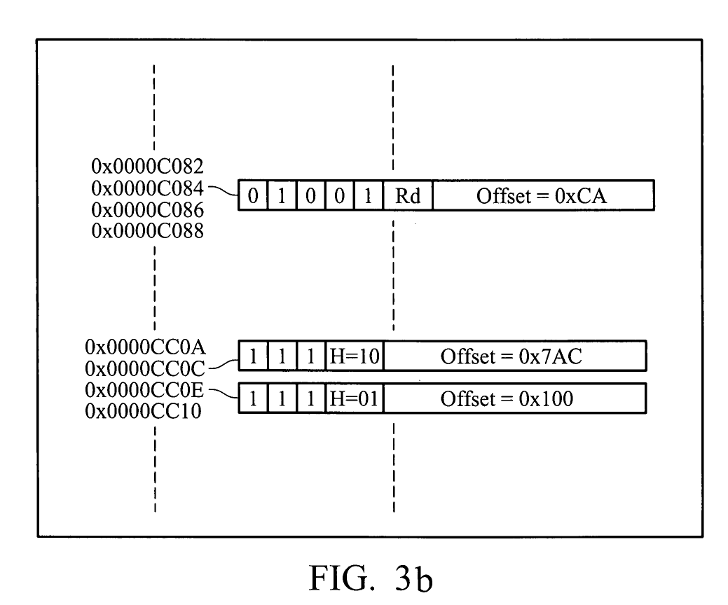

FIG. 3a shows an embodiment of a pre-filter 202 according to FIG. 2. The original firmware is input to a buffer 302. Some of the instructions in the original firmware may be address relative instructions comprising offset values referring to addresses of another instruction. An offset value may be recorded in one instruction, or separately recorded in two instructions. The buffer 302 has sufficient capacity to collect one or more relative address instructions jointly forming an offset value. A type detector 304 is coupled to the buffer 302, determining the relative address instruction type. A program counter 308 synchronously counts a number while the relative address instructions are input, serving as an address index. The pre-filter 202 also comprises a plurality of encoders (306a, 306b, . . . ) each coupled to the buffer 302 and the program counter 308, individually converting relative address instructions of different types to corresponding absolute address instructions with reference to the address index provided by the program counter 308. When a relative address instruction is buffered in the buffer 302, a corresponding encoder is activated according to the type determination result from the type detector 304, and a conversion is performed thereafter.

FIG. 3b shows an embodiment of absolute address calculation. For example, if the address of a relative address instruction is 0xC084 as indicated by the program counter 308, and the offset value in the relative address instruction is 0xCA, the encoder obtains an absolute address by the following formulae:
0xC084+0x4+(0xCA<<2)=0xC3B0 (1)
0xC3B0>>2=0x30EC (2)

The shifting terms “<<” and “>>” are specification defined operation while interpreting the addresses. The offset value is then overwritten by the absolute address 0x30EC, Since the bit numbers between the original instruction and the converted instruction should be the same, only 0xEC is stored replacing the original value 0xCA.

In another example, the relative address is represented by offset values of two consecutive instructions starting at address 0xCC0C. The offset values, such as, for example, 0x7AC and 0x100, jointly represent the relative address in the form:
[0x7AC<<12+0x100<1] (3)

To convert the relative address to absolute address, the program counter value 0xCC0C is added thereto, as follows:
[0x7AC<<12+0x100<1]+(0xCC0C+0x4)=0x7B8E10 (4)
0x7B8E10>>1=0x3DC708=(0x7B8<<11)+0x708 (5)

Thus, the offset values 0x7AC and 0x100 are overwritten by 0x7B8 and 0x708, generating two consecutive converted instructions with absolute addresses.

A multiplexer 310 is coupled to the buffer 302, type detector 304 and encoders 306, serving as an output generator. Some of the instructions in the original firmware may not be address relative instructions, and thus are output directly without conversion. The multiplexer 310 selects one output from the buffer 302 and encoders 306 according to the determination of the type detector 304, and outputs it for further compression.

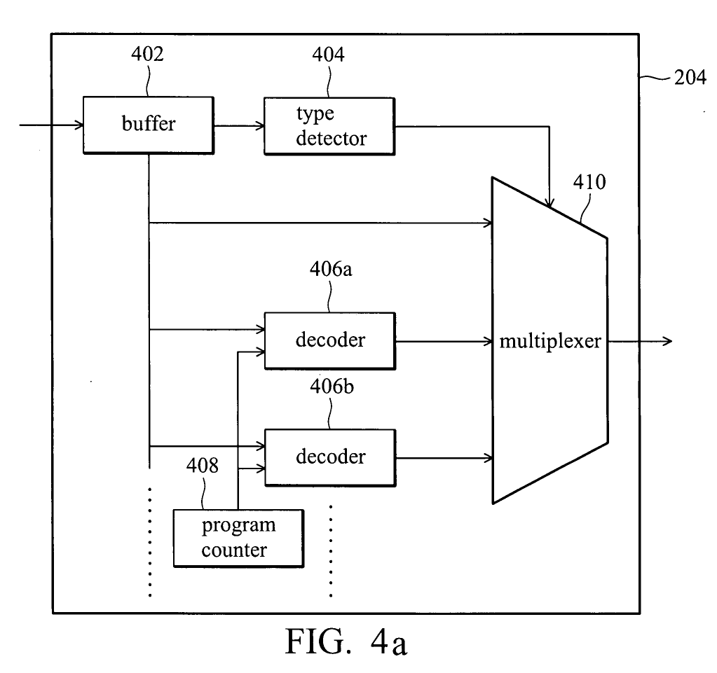

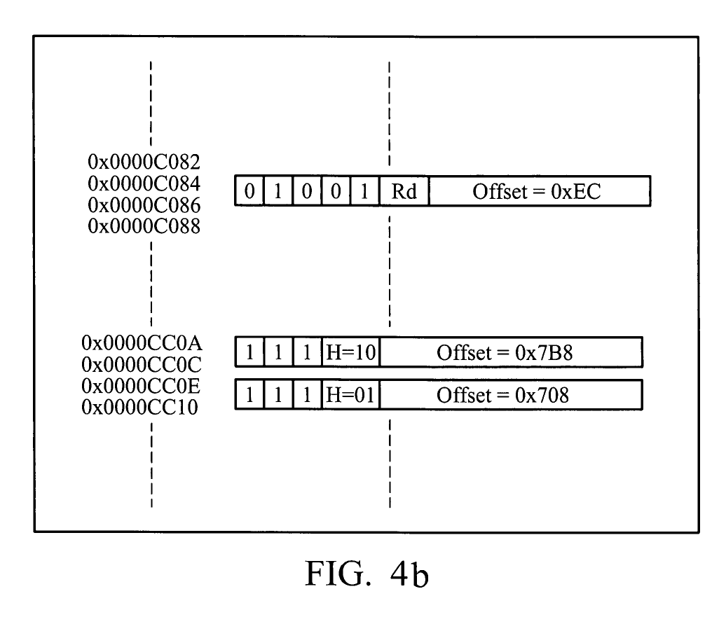

FIG. 4a shows an embodiment of a post-filter 204 according to FIG. 2. The post-filter 204 performs a reverse operation to the pre-filter 202. The decompressor 106 decompresses the encoded firmware from the ROM device 104, and the post-filter 204 is required to convert the absolute address instructions to executable forms. In the post-filter 204, a buffer 402 has sufficient capacity to collect one or more absolute address instructions jointly comprising an address field that directly points to an absolute address. A type detector 404 is coupled to the buffer 402, determining the absolute address instruction type. A program counter 408 provides address indexes for the absolute address instructions. A plurality of decoders (406a, 406b, . . . ), each coupled to the buffer 402 and the program counter program counter 408, individually converts absolute address instructions of different types to corresponding relative address instructions with reference of the address indexes provided by the program counter 408. A multiplexer 410 is coupled to the buffer 402, type detector 404 and decoders, selecting one output from the buffer 402 and decoders according to the determination of the type detector 404, and outputting the selection as the relative address instruction.

FIG. 4b shows an embodiment of relative address calculation. For example, if the address of an absolute address instruction is 0xC084 as indicated by the program counter 408, and the values in the instruction is 0xEC, the decoder 406 obtains an offset value by the following formulae:
(0xEC<<2)−(0xC084+0x4)=0xFFFF4328 (6)
0xFFFF4328>>2=0x3FFD0CA (7)

The 0xEC is then overwritten by the 0xCA.

In another example, 0x7B8 and 0x708 jointly represent the absolute address in the form:
[0x7B8<<12+0x708<1] (8)

To obtain the relative address, the program counter value 0xCC0C is subtracted:
[0x7B8<<12+0x708<1]−(0xCC0C+0x4)=0x7AC200 (9)
0x7AC200>>1=0x3D6100=(0x7AC<<11)+0x100 (10)

Thus, the offset values 0x7AC and 0x100 are written to replace the 0x7B8 and 0x708, generating two consecutive converted instructions with offset values.

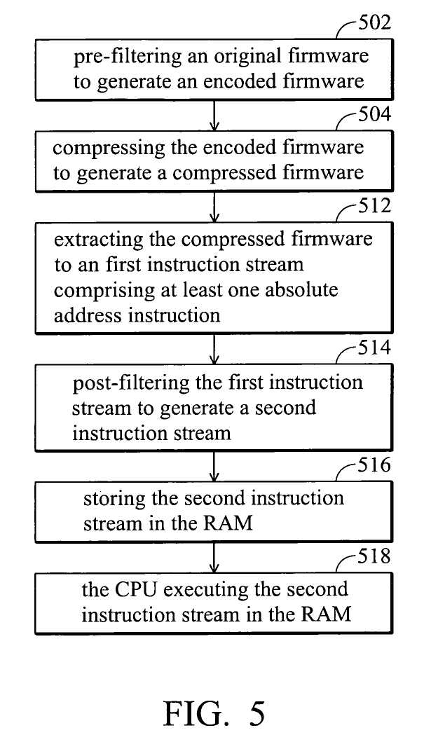

FIG. 5 is a flowchart of the firmware provision and execution method. In step 502, the original firmware is pre-filtered to generate encoded firmware. The relative address instructions therein are converted to absolute address instructions. In step 504, the encoded firmware is compressed and stored in the ROM device 104. To increase firmware execution device 220 performance, the compression algorithm is typically a dictionary based algorithm such as LZ77 or LZ78. Steps 502 and 504 may be performed during the firmware execution device 220 manufacture by a firmware supplier 210. In step 512, when the firmware execution device 220 is powered up, the compressed firmware is extracted by a decompressor 106. In step 514, a post-filter 204 is provided to perform a reverse conversion, generating conventional relative address instructions. In step 516, the output of post-filter 204 is stored in the RAM device 108, executed by the CPU 110 in step 518. The firmware execution device 220 may be a computer, a CD-ROM or embedded system. The relative address instructions are also referred to as program counter relative instructions, conforming to ARM thumb code standards.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A firmware executing device, comprising
a first memory device, storing compressed firmware;
a decompressor, coupled to the first memory device, extracting the compressed firmware to a first instruction stream comprising at least one absolute address instruction;
a post-filter, coupled to the decompressor, filtering the first instruction stream to generate a second instruction stream, whereby the absolute address instruction is converted to a relative address instruction;
a second memory device, coupled to the post-filter, storing the second instruction stream filtered from the post-filter; and
a processor, coupled to the the second memory device, executing the second instruction stream stored in the second memory device.

2. The firmware executing device as claimed in claim 1, wherein the post-filter comprises:
a buffer, having sufficient capacity to collect one or more absolute address instructions jointly comprising an address field that points directly to an absolute address
a type detector, coupled to the buffer, determining which type the absolute address instruction is;
a program counter, providing address indexes for the absolute address instructions;
a plurality of decoders, coupled to the buffer and the program counter, individually converting absolute address instructions of different types to corresponding relative address instructions with reference to the address indexes provided by the program counter; and
a multiplexer, coupled to the buffer, type detector and decoders, selecting one of the outputs from the buffer and decoders according to the determination of the type detector, and outputting the selection as the relative address instruction.

3. The firmware executing device as claimed in claim 1, wherein the decompressor extracts the compressed firmware by a dictionary decompression algorithm.

4. The firmware executing device as claimed in claim 2, wherein when the type detector detects type of the absolute address instruction, a corresponding decoder rewrites the address field with an offset value, the offset value obtained by the targeted absolute address subtracting the corresponding address index.

5. A firmware supplier, coupled to a ROM device to provide compressed firmware, comprising:
a pre-filter, filtering original firmware comprising at least one relative address instruction, to generate encoded firmware, whereby the relative address instruction in the original firmware is converted to an absolute address instruction; and
a compressor, coupled to the pre-filter, compressing the encoded firmware to the compressed firmware by a dictionary compression algorithm; wherein the ROM device is coupled to the compressor storing the compressed firmware.

6. The firmware supplier as claimed in claim 5, wherein the pre-filter comprises:
a buffer, having sufficient capacity to collect one or more relative address instructions jointly comprising an address field that stores an offset value;
a type detector, coupled to the buffer, determining which type the relative address instruction is;
a program counter, providing address indexes for the relative address instructions;
a plurality of encoders, coupled to the buffer and the program counter, individually converting different type relative address instructions to corresponding absolute address instructions with reference to the address indexes provided by the program counter; and
a multiplexer, coupled to the buffer, type detector and encoders, selecting one output from the buffer and encoders according to the determination of the type detector, and outputting the selection as the absolute address instruction.

7. The firmware supplier as claimed in claim 6, wherein when the type detector detects the type of the relative address instruction, a corresponding encoder rewrites the address field with an absolute address, wherein the absolute address is obtained by summing the offset value and the corresponding address index.

8. A firmware executing method, comprising
providing compressed firmware;
extracting the compressed firmware to a first instruction stream comprising at least one absolute address instruction;
filtering the first instruction stream to generate a second instruction stream, whereby the absolute address instruction is converted to a relative address instruction; and
executing the second instruction stream.

9. The firmware executing method as claimed in claim 8, wherein filtering comprises:
collecting one or more absolute address instructions jointly comprising an address field that directly points to an absolute address;
providing address indexes for the absolute address instructions;
converting the absolute address instructions to corresponding relative address instructions with reference to the address indexes.

10. The firmware executing method as claimed in claim 8, wherein the compressed firmware is extracted by a dictionary decompression algorithm.

11. The firmware executing method as claimed in claim 9, wherein filtering further comprises rewriting the address field with an offset value, wherein the offset value is obtained by the targeted absolute address subtracting the corresponding address index.

12. A firmware provision method, comprising:
pre-filtering original firmware comprising at least one relative address instruction, to generate encoded firmware, whereby the relative address instruction in the original firmware is converted to an absolute address instruction; and
compressing the encoded firmware to the compressed firmware by a dictionary compression algorithm.

13. The firmware provision method as claimed in claim 12, wherein pre-filtering comprises:
collecting one or more relative address instructions jointly comprising an address field that stores an offset value;
providing address indexes for the relative address instructions;
converting the relative address instructions to corresponding absolute address instructions with reference to the address indexes.

14. The firmware provision method as claimed in claim 13, wherein the pre-filtering further comprises rewriting the address field with an absolute address, wherein the absolute address is obtained by summing the offset value and the corresponding address index.
